(19) United States
(12) Patent Application Publication
(10) Pub. No.: US 2006/0040561 A1
(43) Pub. Date: Feb. 23, 2006

(54) Memory card connector

(76) Inventors: Wei-Sun Chang, Taipei (TW); Chia-Chien Chang, Xin-Zhuang City (TW); Ming-Hsun Yang, Taipei (TW)

Correspondence Address: MOLEX INCORPORATED, 2222 WELLINGTON COURT, LISLE, IL, 60532, US

(21) Appl. No.: 11/205,494

(22) Filed: Aug. 17, 2005

(30) Foreign Application Priority Data
Aug. 17, 2004 (TW) 93213114

(51) Int. Cl. H01R 24/00

(52) U.S. Cl. 439/630

(57) ABSTRACT

A memory card connector includes an insulative housing which, at least in part, defines a card-receiving space. A plurality of conductive terminals are mounted on the housing and include circuit holding portions, along with contact portions for electrical connection to appropriate contacts on a memory card when the card is inserted into the space. A flexible circuit has conductors for engaging the terminals, with the flexible circuit being held by the holding portions of the terminals.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smart phones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. With circuit board mounted connectors, the terminals of a connector include tail portions which are connected to appropriate circuit traces on the printed circuit board by various systems, such as surface mount technology wherein the tail portions are reflow soldered to the circuit traces, or through hole technology wherein the tail portions of the terminals are inserted into holes in the printed circuit board for connection, as by soldering, to circuit traces on the board and/or in the holes.

Whether the memory card connector is mounted on a printed circuit board or in some other connection apparatus, the connector is permanently or immovably mounted on its supporting structure. For instance, FIG. 1 shows a memory card connection apparatus, generally designated 14, which includes a memory card connector, generally designated 16, mounted within a chassis 18 of the apparatus. A printed circuit board, generally designated 20, is fixed to a bottom wall 18a of the chassis. A front wall 18b of the chassis includes an opening 18c through which a memory card, generally designated 22, is inserted in the direction of arrow “A”. Connector 16 includes an insulative housing 16a which has a rear terminal-mounting connector section 16c for mounting a plurality of conductive terminals 24. The housing, along with a metal shielding cover 26, define a card-receiving space (not numbered) into which memory card 22 is inserted through opening 18c and into the card-receiving space. When fully inserted, contact portions of terminals 24 electrically engage appropriate contacts on the memory card to electrically connect the card to printed circuit board 20. In essence, the board reads the information on the card.

It can be seen that memory card connector 16 is permanently or immovably mounted on printed circuit board 20 which, in turn, is permanently fixed within chassis 18. Terminals 24 are permanently connected, as by soldering, to appropriate circuit traces on the printed circuit board. As a result, connector 16 cannot move in any direction should manufacturing tolerances or assembly procedures make it difficult to insert memory card 22 into the connector. Often, the connector must be pre-positioned and subsequently finally positioned, and this creates both design problems as well as increasing the manufacture and/or assembly costs. The present invention is directed to solving these problems.

### SUMMARY OF THE INVENTION

An object, therefore, of the invention is to provide a new and improved memory card connector of the character described.

In the exemplary embodiment of the invention, the memory card connector includes an insulative housing which, at least in part, defines a card-receiving space. A plurality of conductive terminals are mounted on the housing and include circuit holding portions, along with contact portions for electrical connection to appropriate contacts on a memory card when the card is inserted into the space. A flexible circuit has conductors for engaging the terminals, with the flexible circuit being held by the holding portions of the terminals. The flexible circuit provides a yielding interface between the terminals and an outside electrical device.

According to one aspect of the invention, the holding portions of the terminals are in a linear array, and the flexible circuit comprises a flat flexible circuit. In one illustrated embodiment of the invention, the housing is structured for mounting on a printed circuit board, and the terminals include terminating portions for electrical connection to appropriate circuit traces on the printed circuit board.

According to another aspect of the invention, the terminals are mounted in a connector body which, in turn, is mounted on the insulative housing. In an illustrated embodiment of the invention, a plurality of electrical conductors are provided on the insulative housing for direct engagement with the contacts on the memory card. In one embodiment, the contact portions of the terminals are in engagement with the electrical conductors. In another embodiment, the contact portions of the terminals are disposed for direct engagement with the contacts on the memory card.

The preferred embodiment includes a metal cover mounted across a top of the insulative housing over a substantial portion of the card-receiving space. Finally, the invention is shown herein as embodied in a connector which forms part of a memory card connection apparatus. The connector receives the flexible circuit.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connection apparatus according to the prior art and as described in the Background, above;

FIG. 2 is an exploded, top perspective view of a memory card connection apparatus according to the invention;

FIG. 3 is an exploded, bottom perspective view of the connection apparatus;

FIG. 4 is a top perspective view of the connection apparatus in assembled condition on a printed circuit board and receiving two flexible circuits;

FIG. 5 is a front elevational view of the apparatus, with the flexible circuits removed;

FIG. 6 is a perspective view of the top connector isolate from the remainder of the apparatus, with the terminals of the top connector terminated to the printed circuit board and receiving a first flexible circuit;

FIG. 7 is an exploded perspective view of the top connector shown in FIG. 6;

FIG. 8 is a perspective view of one of the terminals of the top connector shown in FIGS. 6 and 7;

FIG. 9 is a perspective view of an alternative embodiment of one of the terminals of the top connector;

FIG. 10 is an exploded perspective view of the top connector incorporating the terminals of FIG. 9;

FIG. 11 is a perspective view of the top connector of FIG. 10, in assembled condition; and

FIG. 12 is an exploded perspective view of the bottom connector of the apparatus along with its associated components.

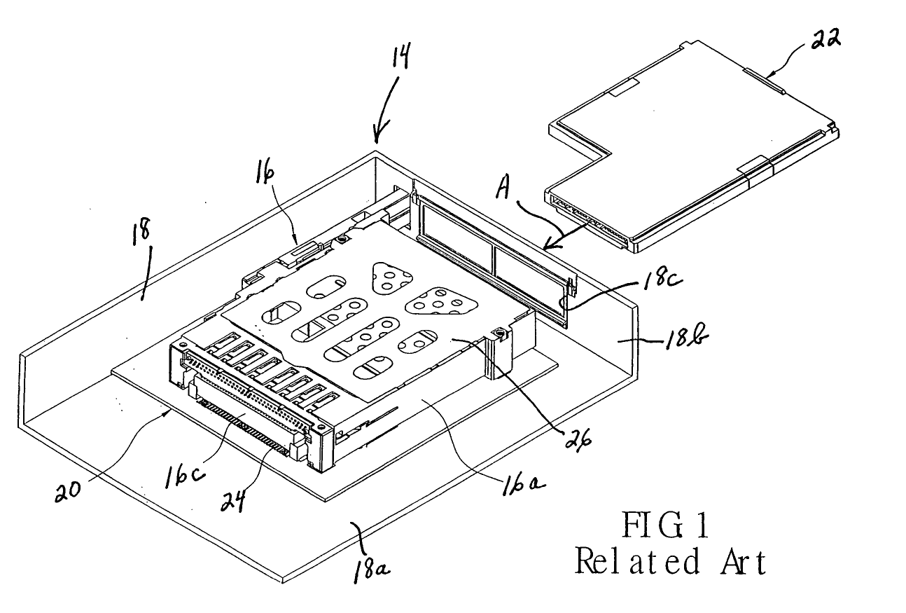

### DETAILED DESCRIPTION OF THE PREFERRED EMBODIMENTS

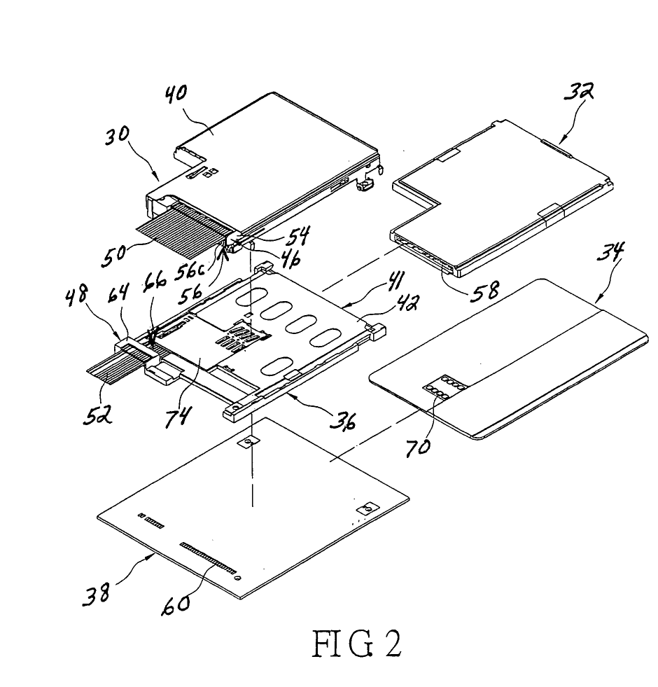

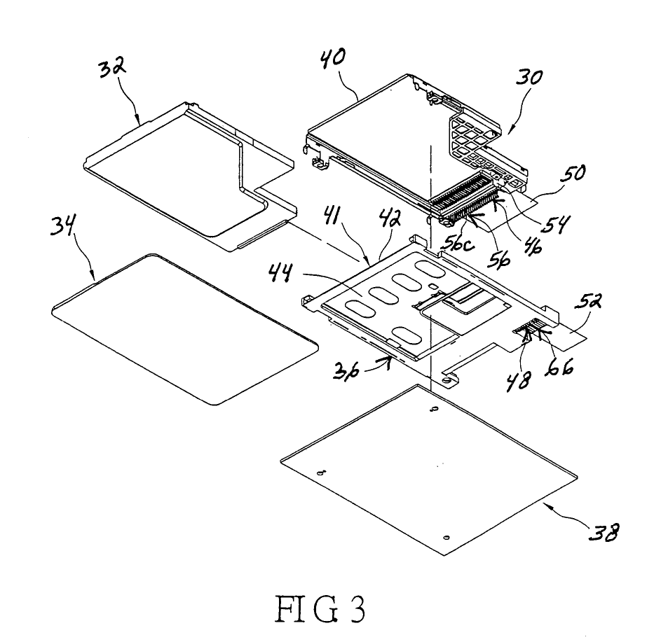

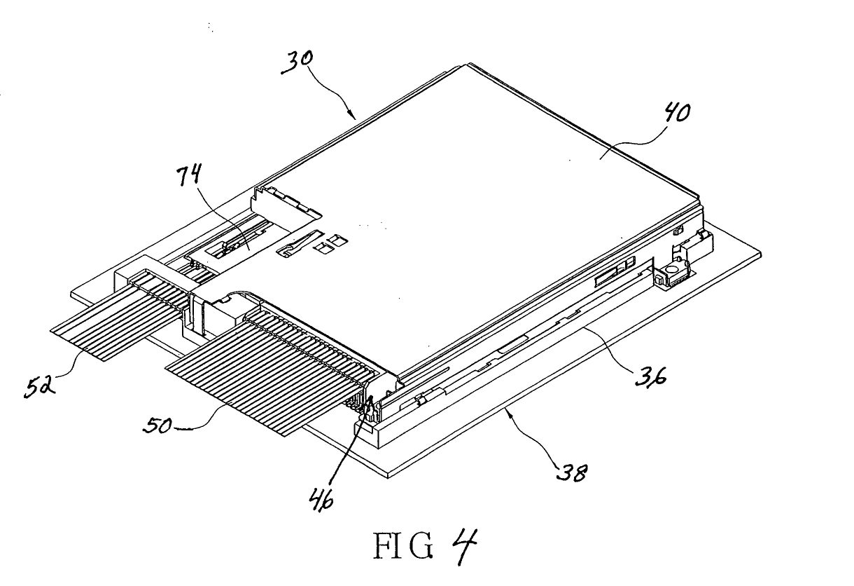

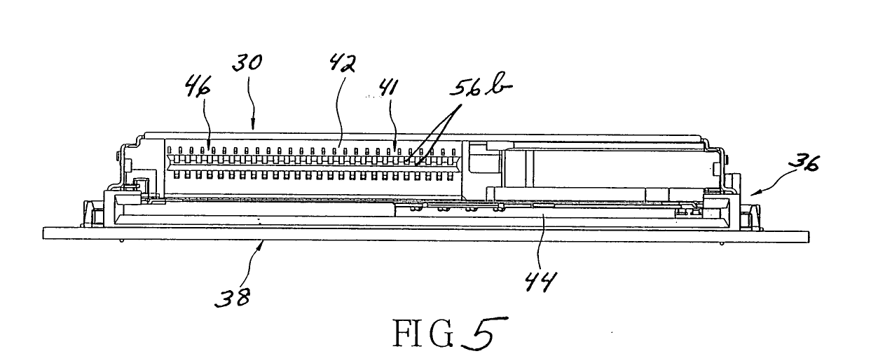

Referring to the drawings in greater detail, and first to FIGS. 2-5, the invention is embodied in a memory card connection apparatus, generally designated 30, for receiving two memory cards, namely a first memory card, generally designated 32, and a second memory card, generally designated 34. Apparatus 30 includes an insulative housing, generally designated 36, which is mounted on a printed circuit board, generally designated 38. A metal cover 40 is mounted on top of the housing. This combined apparatus defines a composite card-receiving space 41 which includes an upper card slot 42 and a lower card slot 44 as can be seen best in FIG. 5. Upper card slot 42 receives first memory card 32, and lower card slot 44 receives second memory card 34. A top connector, generally designated 46, and a bottom connector, generally designated 48, receive first and second flat flexible circuits 50 and 52, respectively, for electrical connection to the first and second memory cards 32 and 34, respectively, as will be seen in greater detail hereinafter.

At this point, it should be understood that the memory card connection apparatus 30 is not limited to a structure for receiving a pair of memory cards 32 and 34. In other words, the card-receiving space 41 could be a single card slot for receiving a single memory card. In addition, the invention is not limited to a structure which is mounted on printed circuit board 38. This printed circuit board could be eliminated, with connectors 46 and 48 electrically coupling first and second memory cards 32 and 34, respectively, to the first and second flexible circuits 50 and 52, respectively.

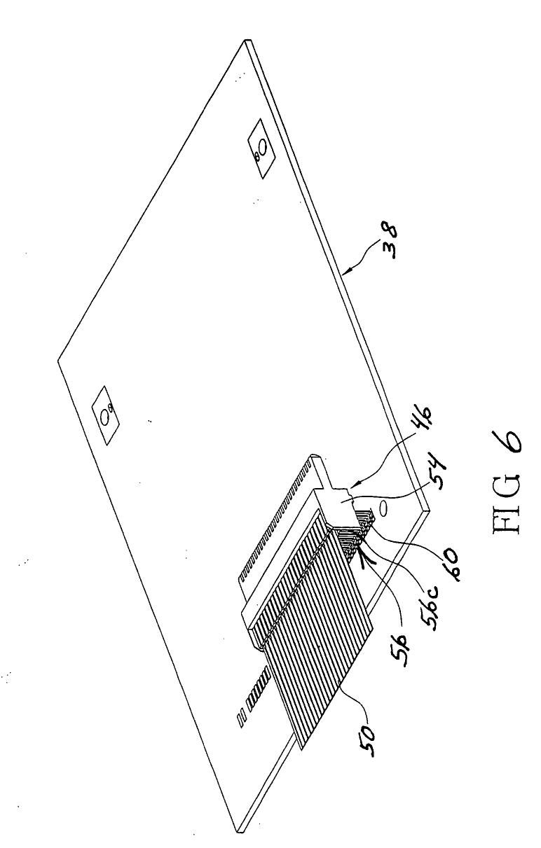

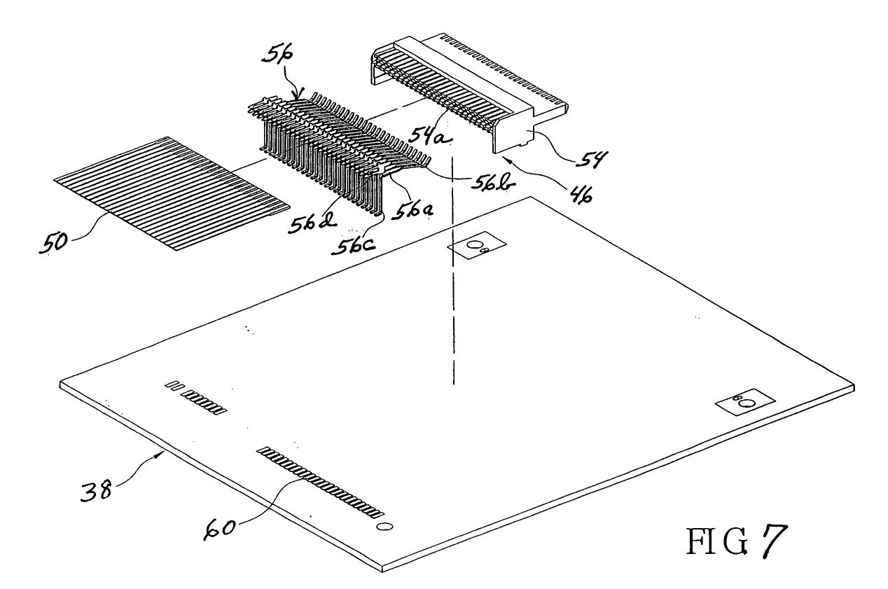

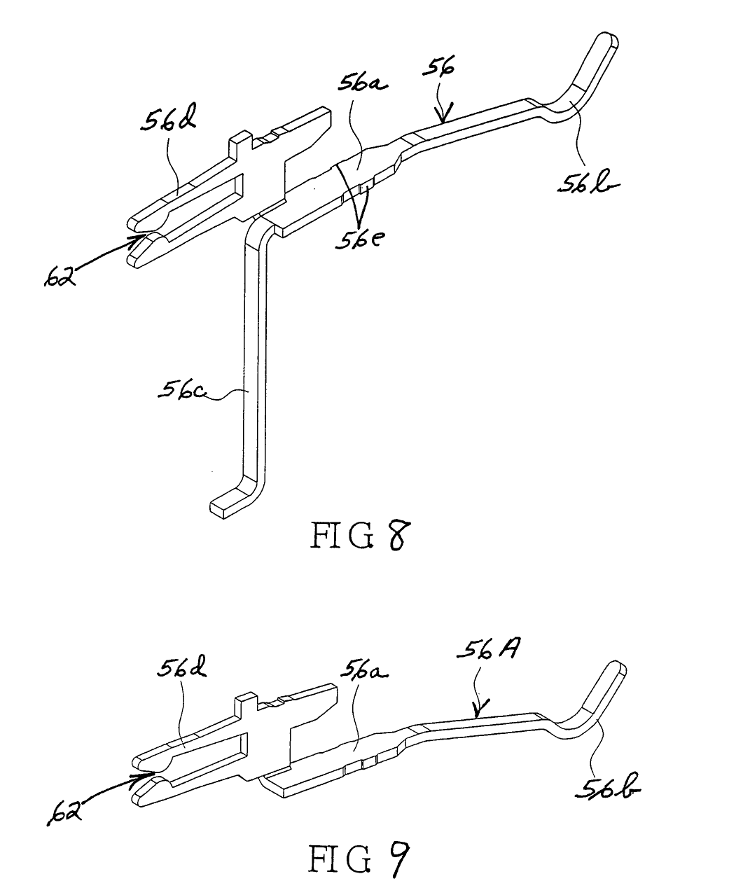

More particularly, top connector 46 is positioned at one end of insulative housing 36 beneath metal cover 40 at the rear of upper card slot 42. Referring to FIGS. 6-8 in conjunction with FIGS. 2-5, top connector 46 includes a dielectric connector body 54 having a plurality of terminal-receiving passages 54a. A plurality of conductive terminals, generally designated 56, are mounted in the passages of the connector body. Each terminal 56 includes a planar fixing portion 56a, a contact portions 56b projecting forwardly thereof, a tail portion 56c projecting downwardly therefrom, and a terminal holding portion 56d bent upwardly at a right-angle to fixing portion 56a. Connector body 54 may be molded of dielectric material such as plastic or the like, and terminals 56 may be stamped and formed of conductive sheet metal material. Fixing portions 56aof the terminals have teeth 56e (FIG. 8) for biting into the plastic material of the body within passages 54a to fix the terminals to the body. Contact portions 56b of the terminals project into the upper card slot 42 as seen in FIG. 5 for engaging contacts 58 (FIG. 2) of first memory card 32. Tail portions 56c of the terminals are connected, as by soldering, to appropriate circuit traces 60 (FIG. 2) on printed circuit board 38. Circuit holding portions 56d of the terminals are bifurcated to define mouths 62 (FIG. 8) for receiving the first flexible circuit 50. The flexible circuit has generally parallel conductors for engaging terminals 56 within the circuit holding portions 56d. Terminals 56 are in a linear array on connector body 54 for receiving a flat flexible circuit, such as the first flexible circuit 50.

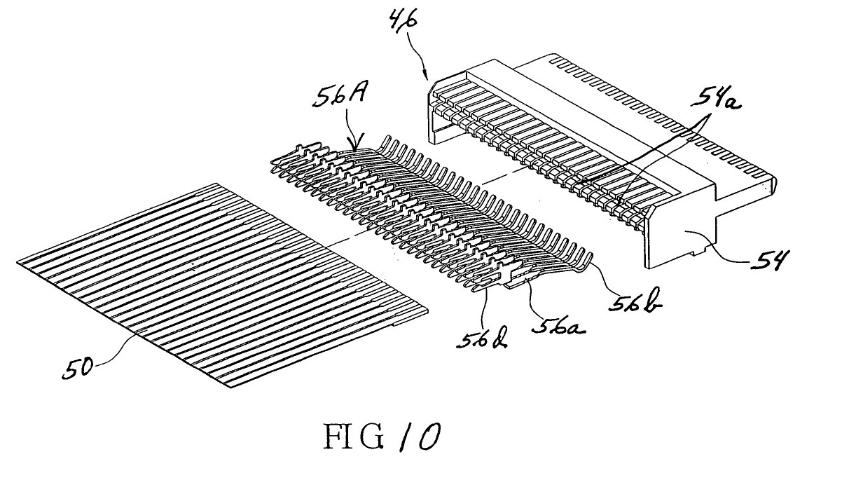

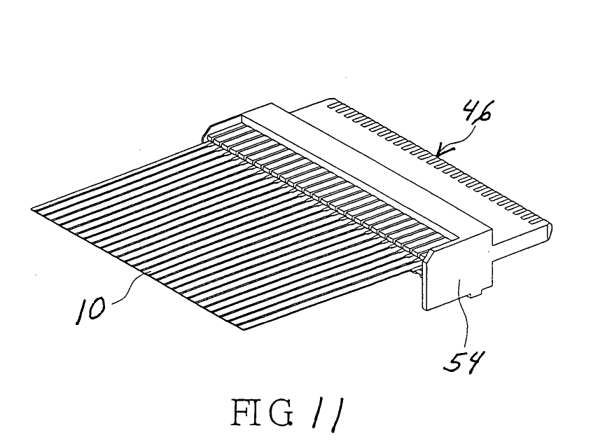

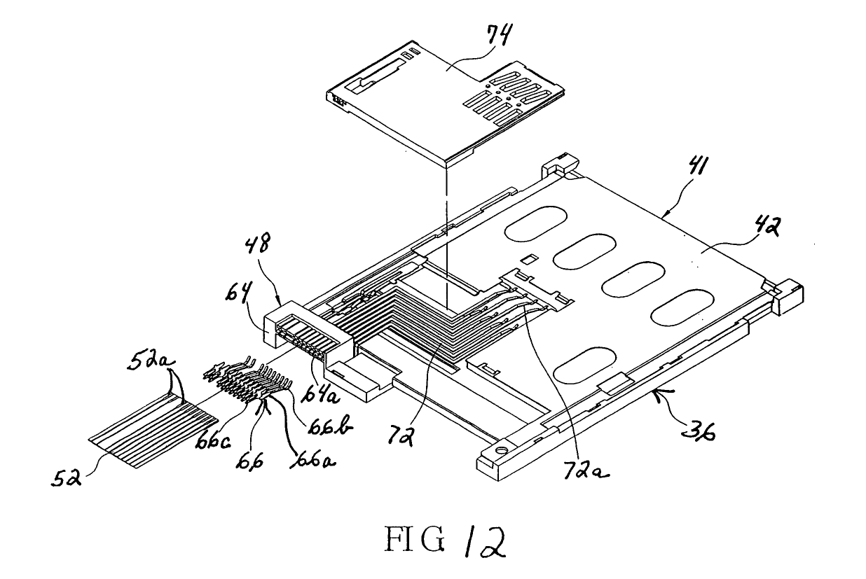

As stated above, the invention contemplates a memory card connection apparatus wherein printed circuit board 38 is eliminated. With such an embodiment, FIGS. 9-11 show that a plurality of terminals, generally designated 56A, are mounted in the terminal-receiving passages 54a of connector body 54 of connector 46. In comparing FIG. 9 with FIG. 8, terminals 56A differ from terminals 56 in that the tail portions 56c (FIG. 8) of terminals 56 have been eliminated, because printed circuit board 38 has been eliminated. In the embodiment of connector 46 shown in FIGS. 9-11, contact portions 56b of terminals 56A again are electrically engageable with contacts 58 of the first memory card 32. Circuit holding portions 56d again hold the first flexile circuit 50 and engage the conductors thereof. In other words, terminals 56A in FIGS. 9-11 transmit signals from memory card 32 to flexible circuit 50 without also transmitting those signals to printed circuit board 38.

Referring to FIG. 12 in conjunction with FIGS. 2-5, bottom connector 48 is located at the rear of insulative housing 36 for receiving the second flexible circuit 52. Like top connector 46, bottom connector 48 includes a dielectric connector body 64 having a plurality of terminal-receiving passages 64a for receiving a plurality of terminals, generally designated 66. Body 64 may be formed integrally with insulative housing 36. Terminals 66 have fixing portions 66a for fixing the terminals within passages 64a of connector body 60. Contact portions 66b of the terminals project forwardly of the fixing portions. Circuit holding portions 66c project rearwardly of the fixing portions for engaging conductors 52 of flexible circuit 52 and, like terminals 56 of top connector 46, the circuit holding portions 66c hold flexible circuit 52 within the connector.

Although the invention contemplates that the terminals of bottom connector 48 can directly engage the contacts of a memory card inserted into lower card slot 44, such as by means of the contact portions 66b of the terminals, FIG. 12 shows an embodiment wherein terminals 66 of the bottom connector indirectly engage the contacts of the second memory card. for instance, second memory card 34 in FIG. 2 may be a Smartcard and has electrical contacts 70 closer to the center of the card. In these situations, a plurality of conductors 72 (FIG. 12) are mounted on insulative housing 36 and the conductors, themselves, have contact portions 72a for engaging contacts 70 of memory card 34. Therefore, contact portions 66b of terminals 66 of the bottom connector engage rear ends of conductors 72, while contact portions 72a of the conductors, in turn, engage contacts 70 of memory card 34. Conductors 72 may be discrete metal wire-like components as shown in FIG. 12 which can be mounted on or insert-molded to housing 36. Alternatively, conductors 72 can be printed or electroplated on the housing. A protective dielectric cover 74 is positioned over the top of conductors 72.

While the memory card connection apparatus 30 may be a rigid structure and may be rigidly mounted within a frame or chassis of an electronic apparatus, flexible circuits 50 and 52 can be electrically connected to appropriate outside electronic devices (not shown), such as a main or primary printed circuit board, and the flexibility of circuits 50 and 52 will allow for relative movement between connection apparatus 30 and the outside electronic device(s). The flexible circuits provide a yielding interface between connection apparatus 30 and the outside electronic device(s). It also should be understood that the invention contemplates that a single memory card connector, such as top connector 46 employing terminals 56A or bottom connector 48 employing terminals 66, can be used in a wide variety of connection apparatus for electrically coupling a memory card to an outside electronic device through a flexible circuit, such as flexible circuits 50 and 52. The memory card connector and flexible circuit can be used, alone, separate from the overall connection apparatus to provide a yielding interface between the connector and the outside electronic device.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector, comprising:
an insulative housing which, at least in part, defines a card-receiving space;
a plurality of conductive terminals mounted on the housing and including circuit holding portions, along with contact portions for electrical connection to appropriate contacts on a memory card when the card is inserted into said space; and
a flexible circuit having conductors for engaging the terminals, with the flexible circuit being held by the holding portions of the terminals.

2. The memory card connector of claim 1 wherein the holding portions of said terminals are in a linear array and the flexible circuit comprises a flat flexible circuit.

3. The memory card connector of claim 1 wherein said housing is structured for mounting on a printed circuit board and the terminals include terminating portions for electrical connection to appropriate circuit traces on the printed circuit board.

4. The memory card connector of claim 1, including a metal cover mounted across a top of the insulative housing over a substantial portion of the card-receiving space.

5. The memory card connector of claim 1 wherein said terminals are mounted in a connector body which, in turn, is mounted on an insulative housing.

6. The memory card connector of claim 1, including a plurality of electrical conductors on the insulative housing for direct engagement with the contacts on the memory card, the contact portions of said terminals being in engagement with the electrical conductors.

7. The memory card connector of claim 1 wherein the contact portions of said terminals are disposed for direct engagement with the contacts on the memory card.

8. A memory card connection apparatus, comprising:
an insulative housing which, at least in part, defines a card-receiving space;
a connector mounted on the housing and including a dielectric body and a plurality of conductive terminals mounted on the dielectric body, the terminals including circuit holding portions, along with contact portions for electrical connection to appropriate contacts on a memory card when the card is inserted into said space; and
a flexible circuit having conductors for engaging the terminals, with the flexible circuit being held by the holding portions of the terminals.

9. The memory card connection apparatus of claim 8 wherein the holding portions of said terminals are in a linear array and the flexible circuit comprises a flat flexible circuit.

10. The memory card connection apparatus of claim 8 wherein said housing is structured for mounting on a printed circuit board and the terminals include terminating portions for electrical connection to appropriate circuit traces on the printed circuit board.

11. The memory card connection apparatus of claim 8, including a metal cover mounted across a top of the insulative housing over a substantial portion of the card-receiving space.

12. The memory card connection apparatus of claim 8, including a plurality of electrical conductors on the insulative housing for direct engagement with the contacts on the memory card, the contact portions of said terminals being in engagement with the electrical conductors.

13. The memory card connection apparatus of claim 8 wherein the contact portions of said terminals are disposed for direct engagement with the contacts on the memory card.

14. The memory card connection apparatus of claim 8 wherein said insulative housing is sized such that the card-receiving space includes first and second card-receiving slots for receiving a pair of first and second stacked memory cards, and including a pair of said connectors mounted on the housing and including first and second sets of terminals for electrical connection to the first and second memory cards, respectively, the sets of terminals being terminated to first and second flexible circuits.

15. A memory card connector, comprising:
an insulative housing for mounting on a printed circuit board and which, at least in part, defines a card-receiving space;
a metal cover mounted across a top of the insulative housing over a substantial portion of the card-receiving space;
a plurality of conductive terminals mounted on the housing and including a linear array of circuit holding portions, along with contact portions for electrical connection to appropriate contacts on a memory card when the card is inserted into said space and terminating portions for electrical connection to appropriate circuit traces on the printed circuit board; and
a flat flexible circuit having conductors for engaging the terminals, with the flat flexible circuit being held by the linear array of holding portions of the terminals.

16. The memory card connector of claim 15 wherein said terminals are mounted in a connector body which, in turn, is mounted on the insulative housing.

17. The memory card connector of claim 15, including a plurality of electrical conductors on the insulative housing for direct engagement with the contacts on the memory card, the contact portions of said terminals being in engagement with the electrical conductors.

18. The memory card connector of claim 15 wherein the contact portions of said terminals are disposed for direct engagement with the contacts on the memory card.

19. A memory card connector, comprising:
an insulative housing which, at least in part, defines a card-receiving space;
a plurality of conductive terminals mounted on the housing and including contact portions for electrical connection to appropriate contacts on a memory card when the card is inserted into said space; and
a flexible circuit engaged with said terminals and having conductors electrically connected to the terminals.

20. The memory card connector of claim 19 wherein the memory card is inserted into one end of the connector and the flexible circuit projects from an opposite end of the connector.
